(19) United States
(12) Patent Application Publication
(10) Pub. No.: US 2020/0408229 A1
(43) Pub. Date: Dec. 31, 2020

(54) ANNULAR DUCT

(71) Applicants: Jayden Harman, Princeville, HI (US); Kimberly Penney, EL CERRITO, CA (US); Bruce Webster, SAN RAFAEL, CA (US)

(72) Inventors: Jayden Harman, Princeville, HI (US); Kimberly Penney, EL CERRITO, CA (US); Bruce Webster, SAN RAFAEL, CA (US)

(73) Assignee: PAX SCIENTIFIC, INC., San Rafael, CA (US)

(21) Appl. No.: 16/979,163

(22) PCT Filed: Mar. 12, 2019
(86) PCT No.: PCT/US19/21808

§ 371 Date: Sep. 8, 2020

Related U.S. Application Data
(60) Provisional application No. 62/761,189, filed on Mar. 12, 2018.

(51) Int. Cl. F15D 1/00; F24F 7/06; F24F 13/02

(52) U.S. Cl. CPC F15D 1/009; F24F 13/02; F24F 7/065

(57) ABSTRACT

An annular duct arrangement configured to cause a flow stream passing through the annular duct arrangement to be expelled from an outlet of the annular duct arrangement in a predetermined flow form.

### FIELD OF THE INVENTION

The present invention is directed to improved fluid flow control devices or ducts.

### BACKGROUND ART

Many devices and methods are known for causing a fluid to flow as a flow stream within a medium. Simple devices include fans and nozzles. In general, the distance that a flow stream will propagate within the medium is very limited as turbulence resulting from the interaction of the flow with the medium causes flow stream to decay rapidly.

### BRIEF SUMMARY OF THE INVENTION

The invention is applicable to the flow of both gases and liquids. Present development has concentrated on embodiments for use with air as the medium, However, initial testing using test devices in water has shown that the invention can be developed for use with liquids as the fluid medium.

The present invention improves the distance that a fluid flow stream, hereinafter referred to as a flow stream, will travel within a medium. The invention generates a flow stream in a medium by expelling a fluid through an annular duct arrangement. The annular duct arrangement provides an outer duct and an inner duct proximate the outlet of the annular duct arrangement. The inner duct may be of different length to the outer duct and may extend somewhat beyond the outlet plane of the outer duct. An outer wall of the inner duct is spaced from an inner wall of the outer duct to provide a gap between the inner duct and the outer duct through which fluid can flow, referred to herein as the annular gap. In general, to enable simplicity of explanation, the ducts of most embodiments are described as being of circular cross-section, co-axially aligned to provide an annular gap. However, there is no such limitation on the configuration and embodiments are noted that utilise ducts of substantially rectangular cross-section. In reading this specification, the text and the drawings are to be interpreted as non-limiting so that all variations that can be reasonably contemplated are to be considered within the scope. In this regard, in particular, the annular gap is not to be construed as limited in any way.

As well as the fluid flowing within the annular gap, fluid flows within the inner duct. The two flows meet at the outlet of the annular duct. The two flows may show differences in velocity, pressure and/or temperature. With proper configuration, including flow rates, the flow stream from the outlet of the annular duct can provide a flow form in the range between:
1. an outer flow stream acting as a sheath to a main flow stream;
2. a close sequence of vortex rings, with or without an outer sheath.

Where the flow form of 1 is produced an observer will merely note that the flow form appears to be maintained further and in the case of the use with an air conditioning device as discussed in relation the second and subsequent embodiments, the temperature difference is thereby carried further into the medium.

Where the flow form of 2 is produce, the vortex rings are generated in a close sequence, it is usual that an observer will detect them as a continuous flow stream or nearly so. Vortex rings can travel a considerable distance in a medium such as air or water before they disperse and therefore the advantages mentioned above for 1 above will also be detected.

The invention is achieved by providing a system and a method for modifying the flow of the air which leaves the duct such that it will travel further and have its temperature modified more slowly than a conventional system. The embodiments of the invention have been devised from the applicant's extensive study and research into fluid flow and in particular in respect of fluid flow in a vortex and especially fluid flow in a ring vortex. The applicant has previously disclosed inventions for a Fluid Flow Controller first published as WO03/056228, Fluid Flow Control Device first published as WO2005/003616, and Vortex Ring Generator first published as WO/2003/056190. These disclosures are essential background to the present invention and are hereby incorporated by reference. Other disclosures are also relevant—see WO97/03291, WO2005/045258. Some uses and methods of generating vortex rings have previously been disclosed in WO_03/056190 published 10 Jul. 2003 in the name of Jayden Harman, one of the present inventors. That document contains substantial discussion about science and use of vortex rings and is hereby incorporated by reference. However, that disclosure did not recognise the manner of generating a flow stream of the present invention, nor the benefits that can be derived by doing so.

### DISCLOSURE OF THE INVENTION

According to a first aspect, the invention resides in an annular duct arrangement is configured to cause a flow stream passing through the annular duct arrangement

to be expelled from an outlet of the annular duct arrangement in a predetermined flow form

the annular duct arrangement comprising

an outer duct having an inner wall

and an inner duct located within the outer duct and proximate the outlet,

and having an outer wall

the inner wall and the outer wall being spaced to provide an annular gap,

a first portion of the flow stream passing through the inner duct

and a second portion of the flow stream passing through the annular gap,

the first portion and second portion interacting after being expelled from the annular duct arrangement in a region proximate the outlet to cause the predetermined flow form.
According to a preferred feature of the invention, the size of the annular gap is selected to optimise the performance of the arrangement.
According to a preferred feature of the invention, the predetermined flow form comprises a continual sequence of vortex rings in close progression to provide the appearance of a continuous flow.
According to a preferred feature of the invention, the predetermined flow also comprises a flow sheath surrounding and protecting the vortex rings, the flow sheath being generated by the second portion of the flow stream.
According to a preferred feature of the invention, the predetermined flow comprises an inner flow stream formed substantially from the first flow portion and an outer flow sheath formed substantially from the second flow portion wherein the outer flow sheath isolates the inner flow.
According to a preferred feature of the invention, the annular duct arrangement is associated with a fan to provide a fan assembly which, in use, enables the annular duct arrangement the flow cause the flow to be in a predetermined flow form which thereby able to be maintained for a greater distance.
According to a preferred embodiment, the annular duct arrangement is associated with an air-conditioning system which causes the temperature of the air exiting the air conditioning system to be altered from that of ambient, and whereby the annular duct arrangement causes the outlet flow stream to adopt a predetermined flow form which enables the temperature difference to be transferred for a distance from the outlet greater than would be able to be achieved by the air conditioning system alone.
According to a preferred embodiment the outer duct has formations on the inner surface directed to imparting a rotating component to the outer flow.
According to a preferred embodiment the inner duct has formations on the outer surface directed to imparting a rotating motion to the outer flow.
According to a preferred embodiment the inner duct has formations on the inner surface directed to imparting a rotating motion to the inner flow.
According to a preferred embodiment the inner flow and outer flow are caused to rotate in the same rotational direction.
According to a preferred embodiment the inner flow and outer flow are caused to rotate in the opposite rotational direction.
According to a further aspect the invention resides in a method of causing a fluid to flow in a predetermined flow form, by causing the fluid to be passed through an annular duct arrangement as previously described.

The invention will be more fully understood in the light of the following description of several preferred embodiments.

### BRIEF DESCRIPTION OF THE DRAWINGS

The description is made with reference to the accompanying drawings, of which:

FIG. 1 is a cross-section representation of a fan assembly according to a first embodiment;

FIG. 2 is a cut-away view of the fan assembly of FIG. 1;

FIG. 3 is an end view of fan assembly of FIG. 1;

FIG. 4 is a diagrammatic end view of the fan assembly of FIG. 1;

FIG. 5a is a diagrammatic representation of the fan assembly of FIG. 1;

FIG. 5b is a further diagrammatic representation of the fan assembly of FIG. 1;

FIG. 6 is a diagrammatic representation of a standardised test system as used to test the embodiments;

FIG. 7 is an isometric view of the general configuration of the ducts of the embodiments;

FIG. 8 is an isometric view of the annular duct arrangement according to a second embodiment;

FIG. 9 is a front view of the annular duct arrangement of FIG. 8;

FIG. 10 is a side view of the annular duct arrangement of FIG. 8;

FIG. 11 is an isometric view of the annular duct arrangement according to a third embodiment;

FIG. 12 is an isometric, longitudinal cross-section of the outer duct of the annular duct arrangement of FIG. 11;

FIG. 13 is an isometric, longitudinal cross-section of the annular duct arrangement of FIG. 11 (both ducts shown);

FIG. 14 is a front view of the annular duct arrangement of FIG. 11;

FIG. 15 is a front view of the annular duct arrangement according to a fourth embodiment;

FIG. 16 is an isometric view of the inner tube of the annular duct arrangement according to a fifth embodiment;

FIG. 17 is a front view of the arrangement of FIG. 16;

FIG. 18 is a diagrammatic representation of the fluid flow provided by the third embodiment, shading variations depicting velocity gradients;

FIG. 19 is a diagrammatic representation of the fluid flow of FIG. 1, shading variations depicting temperature gradients;

### DETAILED DESCRIPTION OF PREFERRED EMBODIMENTS

The present invention provides a system and method to expel a fluid into a fluid medium in a novel manner that enables the flow stream to be expelled in a predetermined flow form.

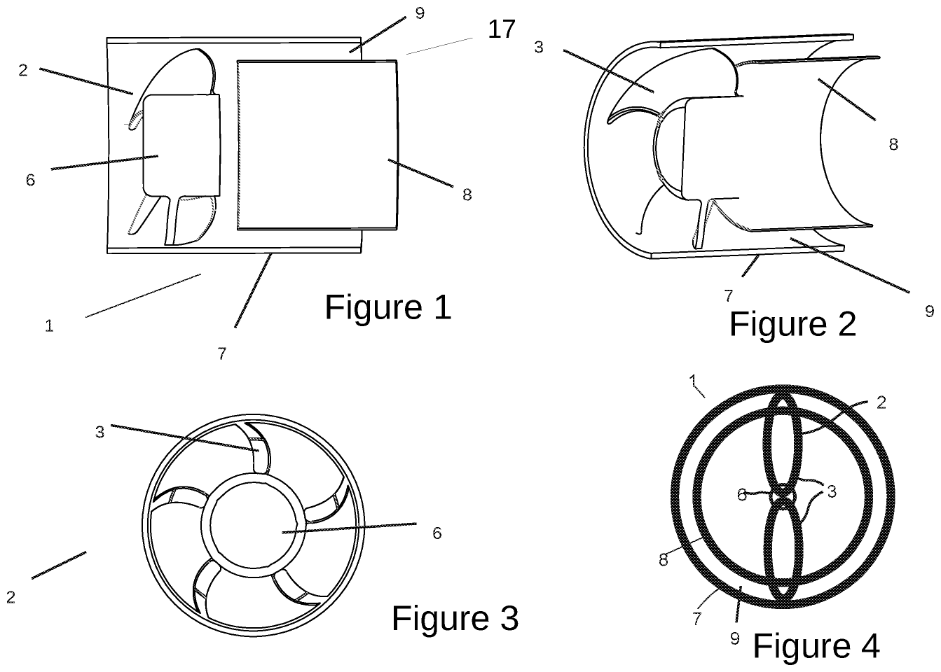

A simple embodiment is described first to help give an understanding of the nature of the invention. The first embodiment is a fan assembly for use in the medium of air and providing a drive operative on the air in the form of a fan rotor to cause the movement of the air through an annular duct assembly. Fans of many types are used to move air for many reasons. One use in domestic and small businesses is to use fans to move air in a room when the ambient temperature is hot. The movement of air over the skin of a person assists evaporation of perspiration which provides a cooling effect. Especially in the early stages, the person may wish the air blown from the fan to strike the person, or at least a portion of the person such as the face, with some force. However, the speed of air flow from a conventional fan dies rapidly after it leaves the fan. To achieve the desired cooling feeling, the person will either place the fan excessively close so that it hinders other tasks, or the fan is driven at a very high speed of rotation which results in unwanted noise and excessive power usage. There a many millions of fans sold annually for domestic use world-wide and while there are many designs they all suffer from these issues. As well, fans for commercial and industrial use also suffer from such problems where it is desired to provide an air flow in a directed stream. The embodiment is described with reference to FIGS. 1 to 5.

As shown in FIGS. 1 to 3, the fan assembly 1 comprises a fan rotor 2 comprising at least one fan blade 3. The fan assembly 1 further comprises an electric motor (not shown) connected by drive shaft 6 to rotate the fan rotor 2. Rotation of the fan causes a flow stream of the air medium.

The fan assembly further comprises two co-axially aligned tubes or ducts of circular cross-section to provide an annular duct arrangement, the outer duct 7 having an inner wall being spaced apart from an outer wall of the inner duct 8 to provide an annular gap 9 between them. Due to the configuration of the the annular duct arrangement relative to the fan rotor 2, the flow stream driven by rotation of the fan rotor 2 is divided into an inner flow stream passing through the inner duct and a outer flow stream passing through the annular gap. After being expelled from the annular at an outlet 17 the inner flow stream and outer flow stream interacting after being expelled from the annular duct arrangement in a region proximate the outlet to cause the outlet flow stream to adopt the desired predetermined flow form.

The resulting flow form expelled from the duct will range between two extremes depending upon the precise configuration of the fan assembly and the flow rate resulting from the fan speed. At one extreme, the annular duct assembly can be configured to cause the combined flow to generate a continual sequence of vortex rings. These vortex rings will be spaced apart sufficiently closely that an observer will not normally detect that the flow stream consists of discrete vortex rings. However, as mentioned before, they will flow significantly further into the air medium than a flow stream from a conventional flow stream and more particularly, can be caused to maintain their shape until they strike the person with the predetermined flow form of a vortex ring. The vortex ring predetermined flow form will normally be generated at relatively low flow rates.

Generally at high flow rates, the flow will cause the alternative extreme of the predetermined flow forms. In this flow form the flow stream will maintain a central core primarily derived from the inner flow stream but the flow stream will also be provided with a significant surrounding sheath generated by the outer flow stream from the annular gap. Preferably both the inner flow and the outer flow will be caused to rotate about the axis of flow. This rotation will tend to occur naturally but can be assisted by formation or other means. This rotation will help stabilize the flow. This is discussed much further in relation to a later embodiments. The flow sheath helps isolate the central core flow from the medium—the atmosphere—and thereby enables the central flow to be sustained for considerably longer distance/time.

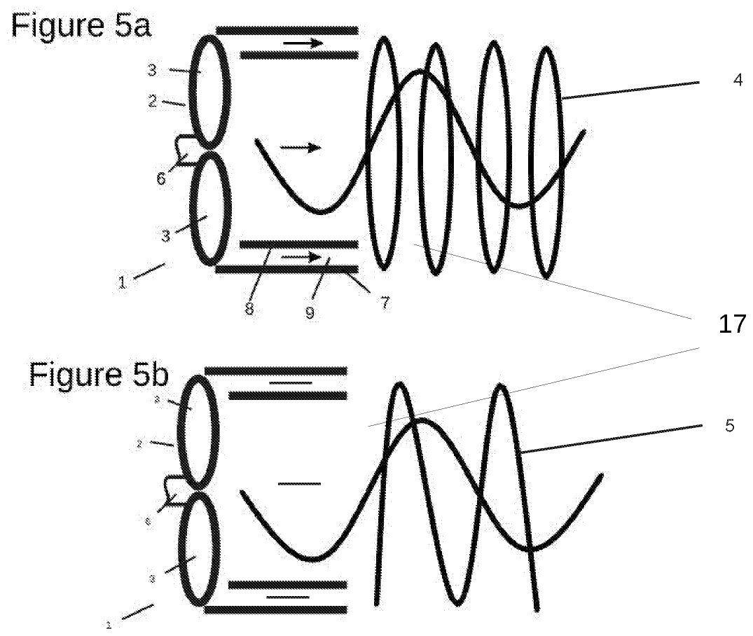

FIGS. 4 and 5a and 5b show the first embodiment of the fan assembly diagrammatically. Particularly in FIG. 5a, it the inner flow stream in the inner duct space 10 and the annular gap 9 are depicted to illustrate the formation of the vortex rings. It may be noted that the different flow rates in the annular gap and the inner duct space occurs because the flow stream from the fan is separated, and flow from fan tips is faster than flow from the body of the blades.

Other embodiments of the invention are directed for use with motor vehicle air conditioning systems. Such systems are well known and comprise systems which cool or warm air and then direct the air through ducts to outlets into the vehicle cabin. Usually a vehicle has lower outlets at the level of the feet of the driver and front passenger as well as upper outlets proximate the face level of passengers on the front console. The design of the lower outlets is usually constrained by very limited space and are not visible so that designers rarely attempt to make a feature of them, so long as sufficient airflow is provided into the cabin. In contrast the upper outlets are usually very visible and designers do attempt to make a feature of them while being constrained by the need for them to be functional but small while complying with safety constraints. It is the functionality of the upper outlets that is addressed by the remaining embodiments.

Functionally, the upper outlets direct air into the cabin that is intended to warm or cool the cabin but also give the front occupants who feel the draft a sense of that the draft itself is having an effect because it strikes them. Rear passengers would also like to feel some of the draft however, in practice, the air temperature from the duct air is rapidly modified by the cabin air temperature so that the rear occupants feel little cooling effect from the draft, and if the journey is short, can leave all occupants with a feeling that the system is ineffective. It is to be noted that the use of the embodiments may be more significant in relation to the cooling of the vehicle, and the development of the present embodiments to date has concentrated on that aspect, but it is believed that the adoption of the present invention for motor vehicle use will enable designers to enhance the effectiveness of the heating aspect by, for instance, designing ducts to direct warm air to the fingers of a driver in icy conditions.

The significant difference between the design of the embodiments proposed for motor vehicle applications rather than that of the first embodiment, is that the object of the improved fan assembly of the first embodiment is to maintain flow rate of the fluid flow for a significantly greater distance from the fan than is possible with conventional fans. In contrast, the embodiments discussed below directed to motor vehicle use seek to provide a system and method for expelling the air from the upper ducts in a manner to enable the expelled air to maintain temperature difference from the ambient air in the cabin for a significantly longer period and/or distance than is achieved with present systems. While the manner of effecting these aim is similar, the different emphasis does effect how various parameters are adjusted. This contrasts with present systems where air from ducts is expelled without any attempt to modify its flow characteristics, other than provide a mechanism for basic alteration of the direction of flow. Such flow is turbulent, and the flow as such disperses rapidly and the temperature changed to ambient a short distance after the air leaves the duct.

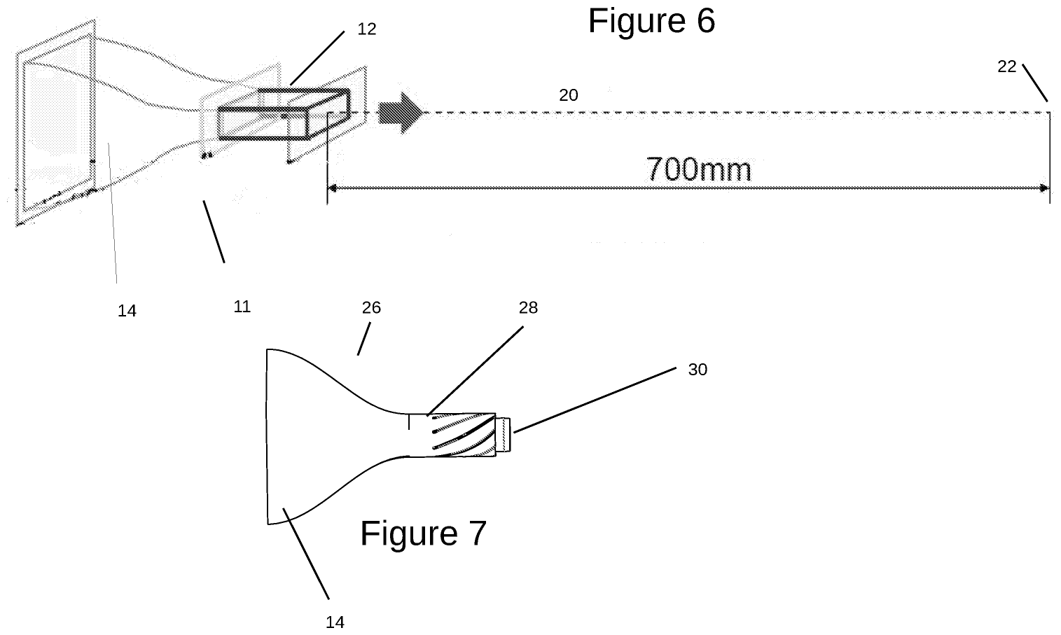

In order to establish a basis for comparison, a standardised test system is described with reference to FIG. 6. As shown in FIG. 6, the standardised system 11 comprises a duct 12 which receives conditioned air from a plenum 14 which has been cooled or heated. In the standardised system 11 as shown, the duct 12 is of rectangular cross-section. However, a simple cylinder 16 may also be used.

All of the embodiments for the standardized test utilise a cylindrical duct. The ducts are 100 mm in length and 50 mm in diameter and have an outlet opening 18 which opens into a controlled open region representing a car cabin 20. Air characteristics are measured at the outlet opening 18 for outlet velocity V0 and outlet temperature T0; a Face location 22 is set at a distance of 700 mm from the outlet representing the distance of an occupant's face from the outlet opening for Face velocity Vx Face temperature Tx as well as the ambient in the car cabin 20 for temperature Ta. For the standardised test conditions Ta is set to 25° C., T0 is set to 10° C. and outlet velocity V is set to 2.8 m/s for low level and 8.5 m's for high level. Face conditions Vx and Tx are monitored.

A system is assessed relative to how it compares with a conventional system.

FIG. 6 and FIG. 7 show an arrangement used by the second and subsequent embodiments that is common and in accordance with the standardised system 11 shown in FIG. 6. The arrangement comprises an annular duct arrangement 26 having an outer duct 28 which corresponds with the duct 12 of FIG. 6, extending from the plenum 14 which supports an inner duct 30. The positioning of the inner duct 30 within the outer duct 26 provides an annular space or gap between those ducts and air from the plenum is caused to flow through ducts. By providing one or both ducts with features that affect the flow of the air, the nature of the air flow can be configured with quite some flexibility. In particular, the arrangement is conducive to causing ring vortex flow to be generated at lower flow rates. In addition, the flow through the annular gap of duct assembly 26 can provides a flow sheath around the ring vortex pulses which appears to assist in the maintenance of the flow within free air to maintain velocity and temperature difference. Each of the embodiments described below are configurations that have been found to be particularly effective for the standardised test condition, but many have been investigated. For differing test and/or operational conditions, other configurations may be optimal.

The second embodiment of the invention is directed to a annular duct arrangement directing air from the air conditioning system into a vehicle cabin. In this regard, it provides an inner flow stream from the inner duct which is surrounded by an outer flow stream from the annular gap in a manner which similar to that of the first embodiment.

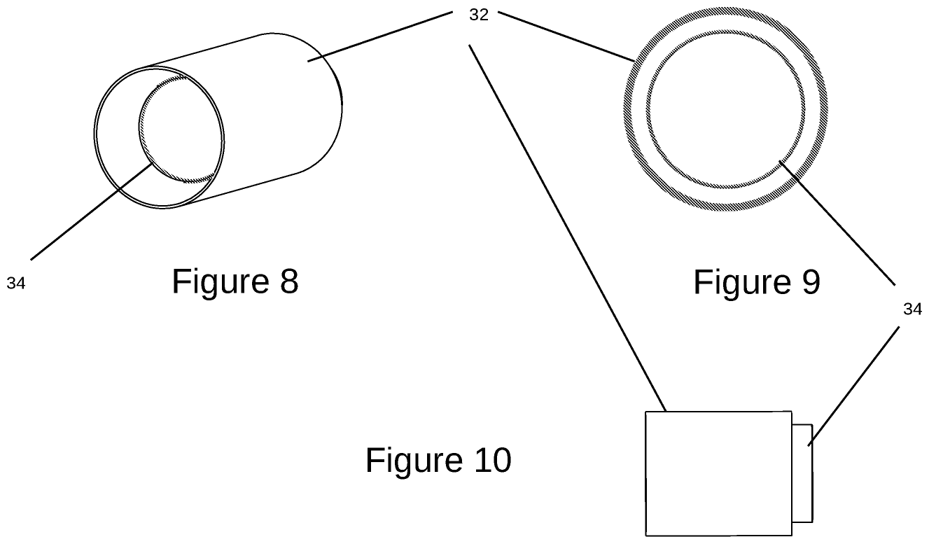

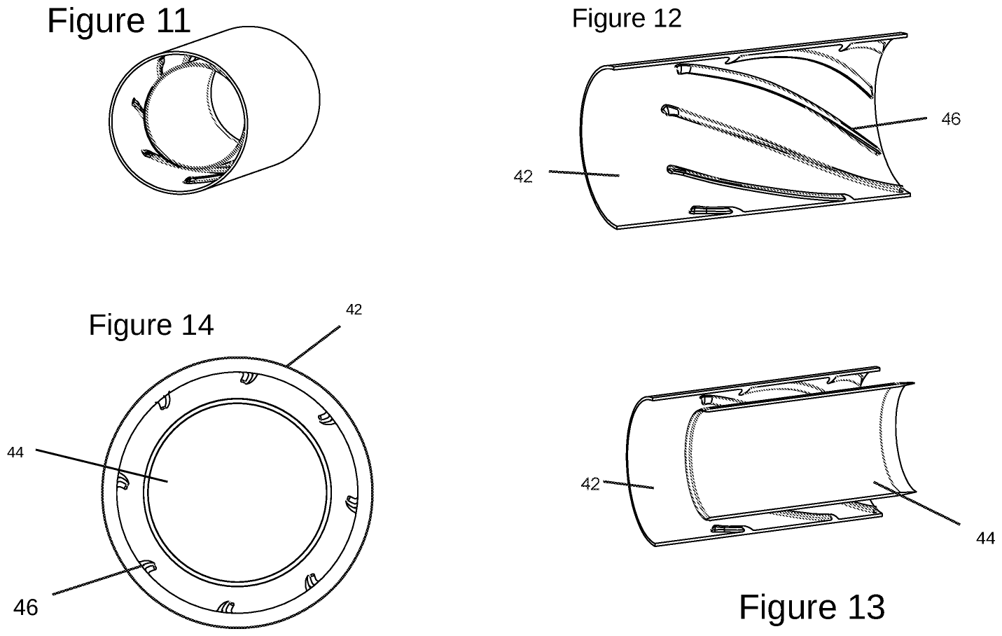

The embodiment is described with reference to FIGS. 8, 9 and FIG. 10.

The embodiment is provided with an arrangement generally in the form as described with respect to FIGS. 6 and 7. The arrangement of the embodiment is provided with a plain cylindrical outer duct 32 and a concentrically aligned plain cylindrical inner duct 34.

In the region where the flow streams are expelled from the annular duct arrangement at its outlet they interact to cause the outlet flow stream to adopt the desired predetermined flow form. The resulting flow form expelled from the annular duct arrangement will range in form between the two extremes discussed in relation to the first embodiment, but in the real motor vehicle use such extremes cannot be achieved but define an operation range. Across the range, the outlet flow is provided with an inner core and with an outer protective flow sheath. This of the flow of the inner core by the protective sheath, means that the temperature difference of the inner core is maintained within the flow stream for distance from the annular duct arrangement significantly further than otherwise. As per the first embodiment, one extreme, the annular duct assembly can be configured to cause the combined flow to generate a continual sequence of vortex rings. These vortex rings will be spaced apart sufficiently closely that an observer will not normally detect that the flow stream consists of discrete vortex rings. However, as mentioned before, they will flow significantly further into the air medium than a flow stream from a conventional flow stream and more particularly, can be caused to maintain their shape until they strike the person with the predetermined flow form of a vortex ring. The vortex ring predetermined flow form will normally be generated at relatively low flow rates.

Generally at very high flow rates, the flow will cause the alternative extreme of the predetermined flow forms. In this flow form the flow stream will maintain a central core primarily derived from the air expelled from the inner duct, but the flow stream will also be provided with a surrounding sheath generated by the flow from the annular gap. Preferably both the central core flow and the flow of the surrounding sheath will be caused to rotate about the axis of flow. This rotation will tend to occur naturally. This rotation will help stabilize the flow.

This is discussed much further in relation to a later embodiments. The flow sheath helps isolate the central core flow from the medium—the atmosphere—and thereby enables the central flow to be sustained for considerably longer distance/time, and in the case of air conditioning systems, thereby prolonging the cooling or heating effect.

It is to be appreciated that in order for the embodiment to act in the manner discussed, the size of annular gap is critical. It has been found that a preferred minimum gap is 5 mm, but test below this figure have been made with some success. It is to be noted that small differences make a substantial change to the performance of the embodiments. The annular gap must be adjusted along with all other parameters in order to enable the annular duct arrangement be able to produce the predetermined flow forms desired.

The third embodiment of the invention is a development of the first embodiment. The embodiment is described with reference to FIGS. 11, to 14.

The third embodiment is provided with a cylindrical outer duct 42 and a concentrically aligned cylindrical inner duct 44. As best seen in a cut-away of the embodiment showing the outer duct only, the outer duct 42 is provided with formations 46 which are intended to assist the flow streams to flow in a curved manner in the mixed flow. In the embodiment, the formations are formed with a curvature which conforms to the Golden Section. The benefits if configuring formations which affect fluid flow have been discussed extensively in the disclosures previously mentioned, and these should be referred to for clarification. Formation of this shape are consistent with the shape of flow of vortexes and ring vortexes in particular and promote the generation of the ring vortexes.

In the region where the flow streams leave the duct assembly they mix and interact to create the ring vortexes, the outer flow stream also provides the vortex ring pulses with a protective flow stream surrounding and flowing with the vortex ring pulses which promote stability and maintenance of the velocity and temperature of the flow stream.

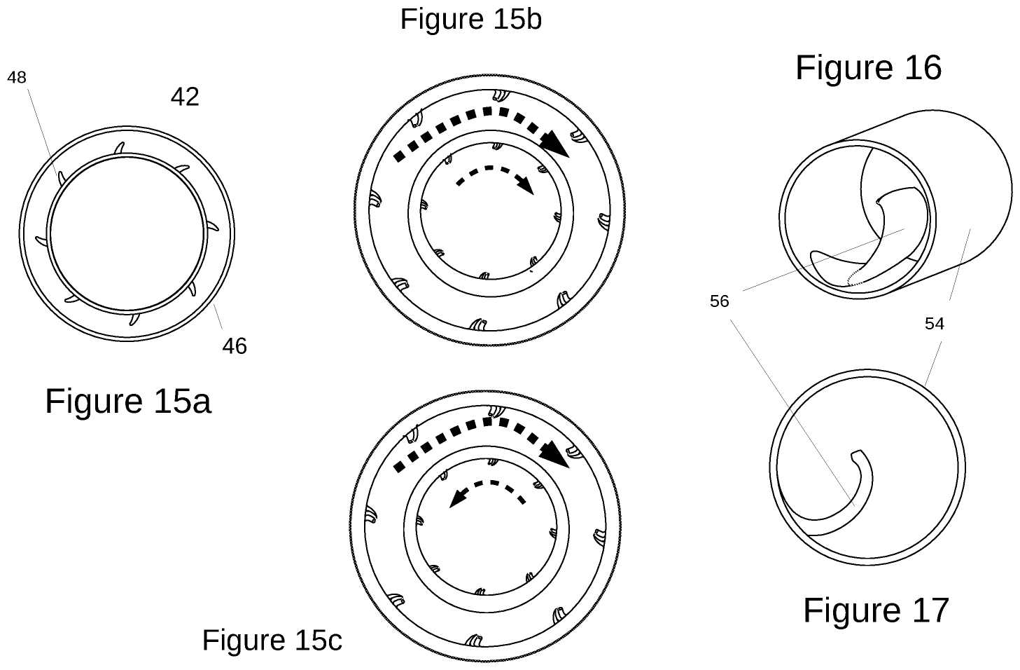

FIG. 15a shows an adaptation of the third embodiment, wherein formations 48 are placed on the inner duct instead of the outer duct. In a further adaptation (not shown), the formation are placed on both of the inner duct and the outer duct.

FIGS. 15b and 15c shows further adaptations of the third embodiment. In these adaptations, both of the annular duct and inner duct are provided with formations to cause both the inner flow stream and the outer flow stream to rotate. In FIG. 15b, both streams are caused to rotate as indicated by the arrows, In FIG. 15c, the streams are cause to rotate with the opposite rotation. Both variations have advantages in certain situations.

Results may be impacted by controlling the direction of either the main flow stream in the central duct or the annular gap flow stream in the outer duct. Vanes or grooves running clockwise or anti clockwise can be used to trigger a counter-rotating or similar rotation of flow as desired.

The fourth embodiment of the invention is a adaptation of the second embodiment. The embodiment is described with reference to FIGS. 16 and 17. In the drawings only the inner duct 54 is shown, the duct being the same as for the first embodiment. In the fourth embodiment, the inner duct 54 is provided with a formation is the form of an aerodynamic wing 56. This wing promotes the flow in the inner tube to form ring vortexes. Again, it is preferably configured in accordance with the principles of Golden Section geometry as discussed above.

However, once the device goes to 20 mm and then 100 mm length scale in diameter, performance is degraded due to the fact that as protective sheath diffuses as it convects downstream, the inner colder core is absorbed in this process. Basically, the need for the inner core zone to be larger than 20 mm in characteristic length seems to be important.’ ‘In addition, the recent studies seems to show that the size of the annular portion is better performer if it is NOT scaled as sizing goes smaller, but rather the annulus size being maintained to be the gap found in the nominal 50 mm diameter case is better.

It is to be understood that while embodiments 2 and subsequent describe systems as used in motor vehicle the invention nay be applied to most forms of cooling and/or heating systems with great where it is desired to provide a fluid flow in a medium where the fluid is heated or cooled

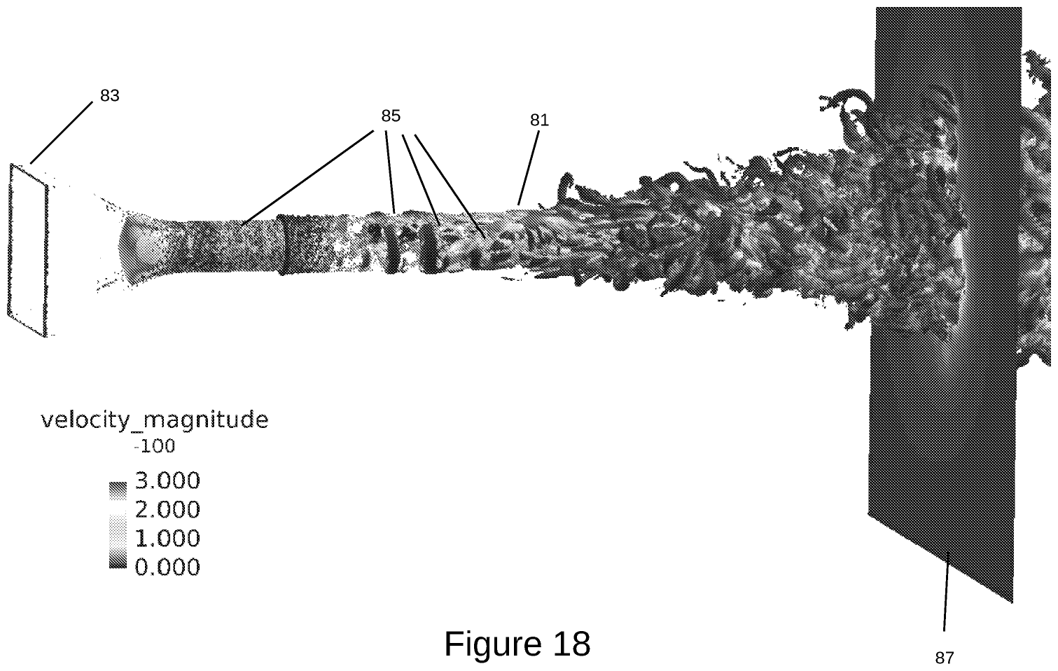

FIG. 18 shows a CFO image of an airflow 81 that is expelled from a duct 83 according to the third embodiment. The original image is in colour with colour variations indicating localised velocity within the flow stream. Obviously the grayscale image loses some of the clarity that is present within the coloured image, particularly as both low speed and high speed extremes convert to dark shades of gray, but importantly, the characteristic vortex rings 85 which are generated by all of the embodiments are quite evident in FIG. 18. An analysis of the coloured image reveals that the velocity is maintained for a considerably further distance than is achieved by a conventional system. This comes about primarily because of the inherent efficiency of the flow within a ring vortex.

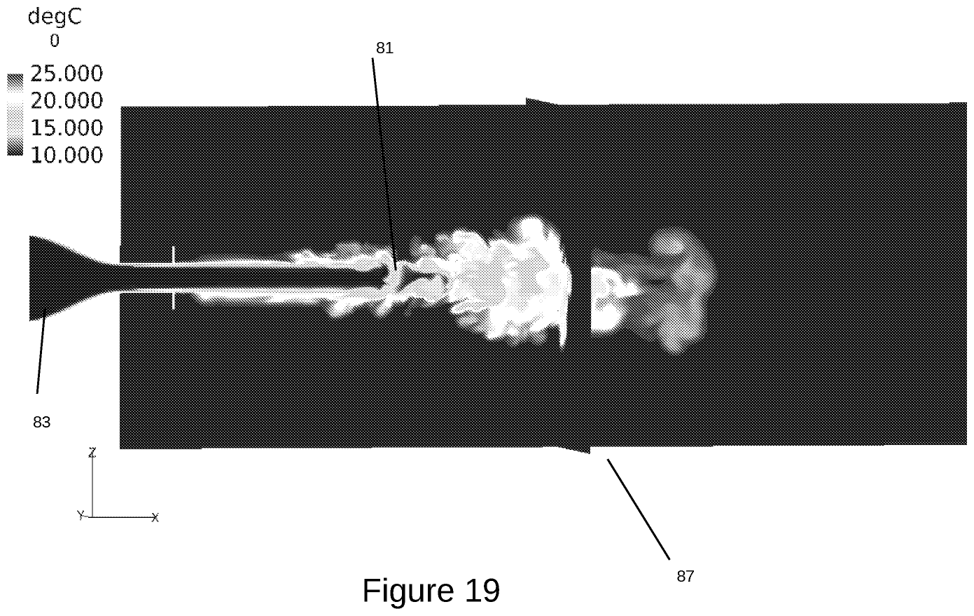

FIG. 19 is a CFO image of the same flow stream as in FIG. 18, but the colour/shading indicates variations in temperature within the airflow.

As a consequence, the ring vortex structure of the stream is far less evident. Again, grayscale conversion has rendered the image less clear than the coloured version as both the hot and cold convert to a dark shade of gray, but an analysis of the coloured image reveals that temperature difference from ambient travels considerably further along the flow stream than is the case with a conventional system.

As FIGS. 18 and 19 are informative rather than substantive it is not considered necessary to provide more at this time. These Figures will be published in colour on the applicant's web site, www.paxscientific.com shortly after publication of the application.

The core insight driving the invention is the concept to intentionally use the outer annulus to develop a distinct outer flow of shed vortices. In the case of the ‘bare’ annulus of the first embodiment, given specific flow rates, the annulus creates complete ring vortices that are ‘puffed’ rapidly so that the successive rings are very close to each other thus forming in time a sheath.

However as higher flow rates are applied to the geometry, this effect is diminished.

Embodiment 2's sheath due to the rifling channels and winglet roll up tip, emanates small ring vortices that form a chain and the chains from each rifled chain braid up together forming the sheath.

Our rifled channel and the winglet with tip has logarithmic shapes in a ‘loose’ sense. But do not precisely have embedded the golden section.

It should be apparent from this specification, that embodiments of the invention may take many forms. The applicant has tested many and only a few have been discussed here. The optimum form or forms will depend upon the precise details of the operating arrangement. For instance if the distance from the duct outlet to the face is doubled, a quite different configuration may be optimum.

Most significantly, it is believed that the method of generating a flow stream as a string of vortex ring pulses and encasing that stream in a protective sheath of the gas is novel and has application far beyond the automotive field described above. It is to be understood that all such uses of the invention are to be considered to be within the scope of the invention.

1. An annular duct arrangement configured to cause a flow stream passing through the annular duct arrangement
to be expelled from an outlet of the annular duct arrangement in a predetermined flow form to provide an outlet flow stream
the annular duct arrangement comprising
an outer duct having an inner wall
and an inner duct located within the outer duct and proximate the outlet,
and having an outer wall
the inner wall and the outer wall being spaced to provide an annular gap,
an inner flow stream of the flow stream passing through the inner duct
and an outer flow stream of the flow stream passing through the annular gap,
the inner flow stream and the outer flow stream interacting after being expelled from the annular duct arrangement in a region proximate the outlet to cause the outlet flow stream to adopt the desired predetermined flow form.

2. An annular duct arrangement as claimed in claim 1
wherein the size of the annular gap is selected to optimise the performance of the arrangement.

3. An annular duct arrangement as claimed in claim 2
wherein the predetermined flow form comprises a continual sequence of vortex rings in close progression to provide the appearance of a continuous flow.

4. An annular duct arrangement as claimed in claim 3
wherein the predetermined flow also comprises a flow sheath surrounding and protecting the vortex rings, the flow sheath being generated by the second portion of the flow stream.

5. An annular duct arrangement as claimed in claim 2
wherein the predetermined flow comprises
an inner flow stream formed substantially from the first flow portion and an outer flow sheath formed substantially from the second flow portion wherein the outer flow sheath isolates the inner flow.

6. An annular duct arrangement as claimed in claim 1
wherein the annular duct arrangement is associated with a fan to provide a fan assembly to enable, in use the flow stream

7. An annular duct arrangement as claimed in claim 1
wherein the annular duct arrangement is associated with a fan to provide a fan assembly which, in use, enables the annular duct arrangement the flow cause the flow to be in a predetermined flow form which thereby able to be maintained for a greater distance.

8. An annular duct arrangement as claimed in claim 1
wherein the annular duct arrangement is associated with an air-conditioning system which causes the temperature of the air exiting the air conditioning system to be altered from that of ambient, and whereby the annular duct arrangement causes the outlet flow stream to adopt a predetermined flow form which enables the temperature difference to be transferred for a distance from the outlet greater than would be able to be achieved by the air conditioning system alone.

9. An annular duct arrangement as claimed in claim 1 wherein the outer duct has formations on the inner surface directed to imparting a rotating component to the outer flow.

10. An annular duct arrangement as claimed in claim 1 wherein the inner duct has formations on the outer surface directed to imparting a rotating motion to the outer flow.

11. An annular duct arrangement as claimed in claim 1 wherein the inner duct has formations on the inner surface directed to imparting a rotating motion to the inner flow.

12. An annular duct arrangement as claimed in claim 1 wherein the inner flow and outer flow are caused to rotate in the same rotational direction.

13. An annular duct arrangement as claimed in claim 1 wherein the inner flow and outer flow are caused to rotate in the opposite rotational direction.

14. A method of causing fluid to flow in a predetermined flow form, wherein fluid is passed through an annular duct arrangement as claimed in claim 1.
